(19) United States
(12) Patent Application Publication
(10) Pub. No.: US 2025/0242622 A1
(43) Pub. Date: Jul. 31, 2025

(54) METHOD FOR OPERATING A WEB-FED PRINTING PRESS

(71) Applicant: Heidelberger Druckmaschinen AG, Heidelberg (DE)

(72) Inventor: Werner Schwab, Bechtsrieth (DE)

(21) Appl. No.: 19/039,813

(22) Filed: Jan. 29, 2025

(30) Foreign Application Priority Data
Jan. 31, 2024 (DE) 10 2024 102 733.9

(51) Int. Cl. B41M 1/04; B41M 1/10; B41M 7/00; B65H 19/18

(52) U.S. Cl. CPC B41M 1/04; B41M 1/10; B41M 7/009; B65H 19/1805; B65H 2301/46013; B65H 2801/21

(57) ABSTRACT

A method for operating webfed printing presses producing printed products, includes providing a reel stand and printing units. A flying web change from first to a second webs takes place with production of a splice, and settings are made on printing units coordinating with passage of the splice through the press. At least two printing units are configured as double printing units for flexographic printing and operated for producing printed products. Each double printing unit includes first and second partial printing units, and first or second partial printing units are activated or deactivated according to passage of the splice through the press, or a switchover occurs from first to second partial printing units of the double printing unit, or vice versa. The flexographic printing press is operable nonstop and automatically during web change. When operating a web-processing rotary printing press for flexographic printing, automation, productivity and print quality increases.

### CROSS-REFERENCE TO RELATED APPLICATION

This application claims the priority, under 35 U.S.C. § 119, of German Patent Application DE 10 2024 102 733.9, filed Jan. 31, 2024; the prior application is herewith incorporated by reference in its entirety.

### FIELD AND BACKGROUND OF THE INVENTION

The invention relates to a method for operating a web-fed printing press for producing printed products, including a reel stand and a plurality of printing units, wherein a flying web change from a first web to a second web takes place with the production of a splice, and settings are made on the printing units in coordination with the passage of the splice through the web-fed printing press. The invention also relates to a method for operating a web-fed printing press, wherein a flying web change from a first web to a second web takes place with the production of a splice.

The invention lies in the technical field of the graphics industry and in particular in the field of operating a flexographic printing machine, i.e., a rotary printing machine for printing with flexographic printing forms on web-like printing stock. In particular, the invention lies in the field of controlling the machine or its drives and/or actuators to increase print quality and productivity and/or avoid or reduce malfunctions.

Japanese Publication JP2006321213A discloses an offset web-fed printing press with a web changer and a plurality of printing units. When a web reel is almost used up, a new web reel with substantially the same web material, i.e., web material which still matches the existing print job, is changed on the fly or both webs are joined together at a splice. During such a web change, register changes can occur as a result of the creation of the splice and its passage through the press, and therefore the register settings of the printing units need to be adjusted. This adjustment appears to be coordinated with the passage of the splice through the web-fed printing press. It is not disclosed that a print image change takes place at the same time as the web change, that the two webs differ significantly (e.g. in web thickness, web width or web material) or that plate cylinders or offset cylinders are switched off when the register adjustments are made. It also seems to address only the length register, but not the cross register. Register sensors are mentioned, but not their measuring positions. A database can be accessed when making register adjustments.

A web-processing flexographic printing machine with double printing units is known, for example, from German Patent Application DE 10 2017 222 700 A1, corresponding to U.S. Pat. No. 10,919,289 B2 or German Patent Application DE 10 2021 126 115 A1.

During continuous operation of a flexographic printing press (highly productive “non-stop” operation), a web change can occur, wherein the two webs differ significantly in at least one web parameter, in particular in the web thickness. This can occur, for example, during a job change. Print shop operators require that such a change does not interrupt production, does not reduce print quality and generates little or no waste. Print shop operators are also demanding further automation of the printing presses in order to save on personnel costs or to be able to replace missing personnel.

### SUMMARY OF THE INVENTION

It is accordingly an object of the invention to provide a method for operating a web-fed printing press, which overcomes the hereinafore-mentioned disadvantages of the heretofore-known methods of this general type and which creates an improvement over the prior art which, in particular, makes it possible to operate a flexographic printing press non-stop and automatically during web changes.

### Solution to the Problem According to the Invention

With the foregoing and other objects in view there is provided, in accordance with the invention, a method for operating a web-fed printing press for the production of printed products, which comprises providing a reel stand and a plurality of printing units, carrying out a flying web change from a first web to a second web with the production of a splice, making adjustments at the printing units in coordination with the passage of the splice through the web-fed printing press, at least two printing units of the web-fed printing press each being configured and present as a double printing unit for flexographic printing and being operated for the production of printed products, each double printing unit present including a first partial printing unit and a second partial printing unit, and a respective first partial printing unit or second partial printing unit being activated or deactivated in coordination with the passage of the splice through the web-fed printing press, or a switchover being made from a first partial printing unit to a second partial printing unit of the respective double printing unit—or vice versa.

Advantageous and therefore preferred developments of the invention can be found in the dependent claims and in the description and drawings.

With the objects of the invention in view, there is concomitantly provided a further, alternative, method for operating a web-fed printing press, wherein a flying web change from a first web to a second web takes place, producing a splice, and at least two plate cylinders of separate printing units are each disengaged from the first web or are each engaged with the second web in coordination with the passage of the splice through the web-fed printing press.

### Advantageous Embodiments and Effects of the Invention

The invention makes it possible in an advantageous way to operate a flexographic printing press non-stop and automatically during web changes.

The invention is advantageously used in the operation of a web-processing rotary printing press for flexographic printing; it increases its degree of automation, productivity and print quality.

The invention advantageously avoids production interruptions and thus reduces production costs. The invention advantageously reduces or avoids waste and thus also reduces production costs. The invention advantageously improves the print quality, e.g. by quickly and optimally adjusting the pressure (plate cylinder to impression cylinder), whereby in flexographic printing in particular squeezed edges or misprints or too low a pressure can be avoided. The invention makes it possible to use fewer personnel or less trained personnel, thereby further reducing production costs.

The invention can be used in particular for so-called flying job changes, e.g. from a first print job for a first product (first print image, first web material, first web thickness) to a second print job for a different second product (second print image, second web material, second web thickness). The products can preferably be packaging.

According to the invention, “the switchover from a first partial printing unit to a second partial printing unit of the respective double printing unit, for example, is coordinated with the passage of the splice through the web-fed printing press.” Since the splice passes through the double printing units of the printing press one after the other, the switchover takes place double printing unit by double printing unit, i.e., not simultaneously at all printing units, but with a time offset corresponding to the respective web travel time from double printing unit to double printing unit. Preferably, all double printing units are ultimately switched over.

The activation, deactivation or switchover in the double printing unit preferably takes place close to the time at which the splice passes the printing gap between the plate cylinder and the impression cylinder and preferably successively, i.e., from printing unit to printing unit step by step and one after the other. In this way, waste can be optimally reduced. In the best case, the switchover takes place as soon as the splice passes the printing nip. The switchover is therefore synchronized with the movement of the splice through the web-fed printing press. It would be desirable for the switchover to take place very close in time to the passage of the splice through the double printing unit and in particular through the printing nip formed there. However, the time-varying location of the splice must be known for this, for which a signal from the splicer or a corresponding sensor and preferably a computer are used. Since the speed of web transport in industrial web-fed printing presses is extremely high, it is therefore advantageous to position the sensor at an appropriate distance in front of the printing unit/in front of the printing nip in order to be able to trigger a corresponding reaction for the switchover process in good time.

Similarly, a single printing unit (or several, preferably successively disposed) can be activated or deactivated in accordance with the passage of the splice through the web-fed printing press. The single printing unit can, for example, be a coating unit with a coating cylinder; in this case, the single printing unit can remain switched on during a web change.

The invention can be extended to machines or units for further processing, e.g., for punching, folding, gluing or palletizing. Such machines or units can be switched over automatically when the substrate is changed: For example, settings for the punching and/or folding can be adjusted depending on the substrate.

Instead of flexographic printing, the invention can also be used in other printing processes, e.g. gravure printing.

### DEVELOPMENTS OF THE INVENTION

Preferred developments of the invention (in short: developments) are described below. Unless technically impossible, these can also be combined with one another.

One development can be distinguished in that the second partial printing units or their respective flexographic plate cylinders—or, conversely, correspondingly the first partial printing units or their respective flexographic plate cylinders—are engaged with the second web at a speed adapted to the speed of the second web at the time of switchover. One development can be distinguished in that the second partial printing units or their respective flexographic plate cylinders—or, conversely, correspondingly the first partial printing units or their respective flexographic plate cylinders—are engaged with the second web with a pressure or advance adapted to the second web or its web parameters at the time of switchover. One development can be distinguished in that the pressure or advance is set separately on both lateral sides of the second partial printing unit. For this purpose, the thickness of the web can be measured at several points (in the lateral direction to the transport direction of the web). One development can be distinguished in that anilox cylinders of the second partial printing units—or, conversely, correspondingly anilox cylinders of the first partial printing units—are engaged with the flexographic plate cylinders with a pressure adapted to the second web or its web parameters at the time of switchover. One development can be distinguished in that the second partial printing units or their respective flexographic plate cylinders—or, conversely, correspondingly the first partial printing units or their respective flexographic plate cylinders—are engaged with the second web with a pre-register adapted to the second web or its web parameters at the time of switchover. One development can be distinguished in that the pre-register includes the longitudinal register and the cross register. Preferably, servomotors can be used to implement the engagement—and also the opposing disengagement.

One development can be distinguished in that the output of dryers can be adapted to the second web or its web parameters at the time of switchover. The dryers can be dryers on the web path between the double printing units and/or between the partial printing units.

One development can be distinguished in that a print job change takes place at the time of switchover. One development can be distinguished in that a print image change is carried out when the print job is changed.

One development can be distinguished in that the flexographic plate cylinders of the first partial printing units—or, conversely, the flexographic plate cylinders of the second partial printing unit—are successively disengaged or engaged in a manner coordinated with the passage of the splice through the web-fed printing press. One development can be distinguished in that the flexographic plate cylinders of the first partial printing units—or, conversely, the flexographic plate cylinders of the second partial printing unit—are disengaged directly before the splice or engaged directly after the splice. One development can be distinguished in that the flexographic plate cylinders of the second partial printing units are engaged in coordination with the passage of the splice through the web-fed printing press. One development can be distinguished in that the flexographic plate cylinders of the second partial printing units are engaged directly after the splice. One development can be distinguished in that a flexographic plate cylinder of a printing unit is disengaged directly before the splice and is engaged again directly after the splice.

One development can be distinguished in that the double printing units each include a register sensor (or at least two), and in that the register sensors are changed in their respective measuring positions in accordance with the passage of the splice through the web-fed printing press. One development can be distinguished in that the register sensors are moved transversely to the transport direction of the webs. One development can be distinguished in that the double printing units are each operated with a register control algorithm and at least one register control parameter and that the register control algorithm and/or the register control parameters are changed in accordance with the passage of the splice through the web-fed printing press.

One development can be distinguished in that the first web and the second web differ substantially in at least one web parameter. One development can be distinguished in that the web parameter is one of the following parameters: web thickness, web width, web material, web surface. The web surface differs significantly, for example, if the material is recycled and/or coated on one or two sides and/or calendered and/or drawn and/or extruded. The roughness of the web surfaces of two webs or their color can also vary. The material/surface parameters of a material to be processed can be measured: via reflection or IR spectroscopy or using ultrasound or laser light. The measurement(s) is/are preferably carried out before the printing unit, particularly preferably shortly before the printing unit (little waste paper!). The measurement, in particular of the web thickness, is preferably continuous. The web thickness can preferably be measured using an optical measuring system. Alternatively, the required parameters can be loaded from a database. Alternatively, the required parameters can be stored on the web (e.g. QR code) or the web reel (e.g. QR code or NFC chip) and read out, preferably in the splicer. One development can be distinguished in that the web thickness is determined by sensors. One development can be distinguished in that the web parameters are stored and provided in a digital database.

One development can be distinguished in that the second web is connected to the first web at the splice.

One development can be distinguished in that during the passage of the splice through the web-fed printing press, at least one first partial printing unit is set for a first print job and contributes to the first print job on the first web and that at least one second partial printing unit is set for a second print job and contributes to the second print job on the second web.

One development can be distinguished in that the web tension is adjusted before the double printing units and/or after the double printing units, in particular in that the infeed web tension is adjusted.

One development can be distinguished in that at least one single printing unit is provided in addition to the double printing units.

One development can be distinguished in that when the web width changes—i.e., from a first width to a second, larger or smaller width—at least one sensor or another component, which is disposed at a working distance from the first width, is moved to a safety distance from the second width from there to a new working distance from the second width.

One development can be distinguished in that printing units for gravure printing with gravure cylinders are used instead of the printing units for flexographic printing.

One development of the further method according to the invention can be distinguished in that at least one double printing unit or at least one single printing unit is involved in the disengagement and/or engagement.

The features and combinations of features disclosed in the above sections entitled field and background of the invention, summary of the invention, solution to the problem according to the invention, advantageous embodiments and effects of the invention and developments of the invention and in the following section entitled detailed description of the invention represent—in any combination with one another—further advantageous developments of the invention.

### Example 1: Specific Application

Packaging A with a circumference of 567 mm (“six-pack”) is printed in the printing machine. The corresponding product web WA has a thickness of 300 μm and is located as a reel RA on a winding spindle WA. A reel RB is inserted into the free part of the non-stop unwinder; this reel has a thickness of 250 μm, for example. The packaging B print job with a circumference of 678 mm (“mint tea”) is prepared in the machine while it continues to produce packaging A. Job A is completed when the reel RA is unwound from the winding spindle WA. In the meantime, the winding spindle WB is brought up to machine speed and “spliced”, i.e., the product web BB is glued to the running web BA. The two webs therefore have a different thickness and possibly also a different modulus of elasticity. As soon as the new web BB enters the machine, certain machine parameters are adjusted to minimize waste. Next, print job B, i.e., the corresponding print cylinders, are brought up to speed in the machine and brought into register with each other while the production of packaging A continues. The print job B is then positioned exactly at the point where the new web BB passes the respective printing unit. The print setting, e.g., the pressure/engagement (on the web), is set so that it matches the new substrate with the changed thickness. This is initially done in the front part of the press, where the material is being fed in and print job B is being printed. In the rear part of the printing machine, where print job A is still running, the value 300 μm is still used for the print settings so that no waste paper is produced there. The switchover takes place while the printing machine continues to produce. This means that there are two different product webs BA and BB with different properties in the machine at the same time and the printing machine “manages” the two webs and the two associated print jobs A and B with different pack sizes/pack designs. As time passes, the material change (splice) moves towards the end of the printing machine. At a certain point in time, the change process is completed and only print job B is produced and only web BB is still in the machine.

### Example 2: Specific Setting Changes

The following specifications and adjustments can be changed individually or in groups or all together when passing through the splice:

Printing units involved, web thickness, web width, web material, web modulus of elasticity, web tension, pressure/engagement between plate and impression cylinders and/or between anilox and plate cylinders, print image, print format, pre-register (register presetting), locations of the register marks on the web (axial and circumferential), measuring locations of the register control sensors (axial and circumferential), dryer settings (temperature, fan speed, UV output), speed of the ink pumps.

Other features which are considered as characteristic for the invention are set forth in the appended claims.

Although the invention is illustrated and described herein as embodied in a method for operating a web-fed printing press, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a diagrammatic, longitudinal-sectional view of a web-fed printing press when carrying out a preferred exemplary embodiment of the method according to the invention;

FIG. 2 is a sectional view of a splicer involved in carrying out a preferred exemplary embodiment of the method according to the invention; and

FIGS. 3, 4 and 5 are sectional views of a double printing unit involved in carrying out a preferred exemplary embodiment of the method according to the invention.

### DETAILED DESCRIPTION OF THE INVENTION

The figures show preferred exemplary embodiments of the invention and the developments thereof. Corresponding features are provided with the same reference signs in the figures. Reference signs that are repeated in the figures have been partially omitted for the sake of clarity.

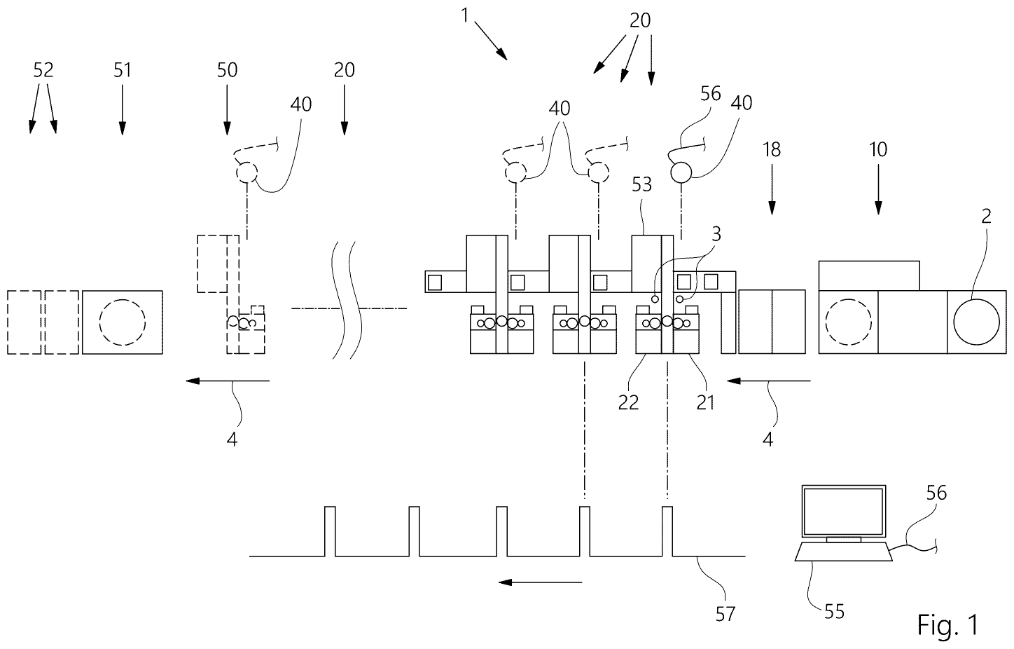

Referring now to the figures of the drawings in detail and first, particularly, to FIG. 1 thereof, there is seen a web-fed printing press 1, in particular for flexographic printing or gravure printing, for printing a substrate web 2, in particular a paper or cardboard web, which is conveyed through the machine 1 in a transport direction 4 via a number of guide rollers 3. The web-fed printing press 1 is preferably controlled via a computer 55.

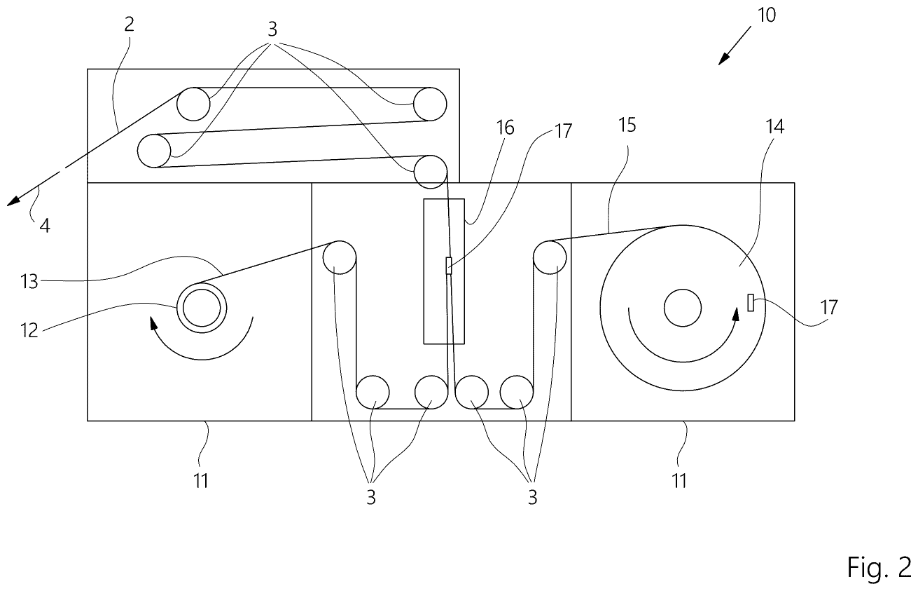

The web-fed printing press 1 includes a reel stand 10 (cf. FIG. 2) for the flying reel change, with two unwinders 11 for unwinding a first reel 12 or a first web 13 and for unwinding a second reel 14 or a different, second web 15. The reel stand 10 further includes a so-called splice device 16 for joining the first web 13 to the second web 15 via a common splice 17 between the two webs 13 and 15. Alternatively, it may be provided that the web 13 or 15 wound and stored on a reel 12 or 13 already has one or more splices 17, i.e., that at least two different webs are wound on the reel and can be unwound therefrom. The reel stand 10 also includes a number of guide rollers 3, which determine the path of the web 2 or its transport direction 4. Downstream of the reel stand 10 is a feed unit 18, which is used, for example, to control the web tension and/or which guides the edges or the center of the web, e.g., when two webs of different widths are glued together.

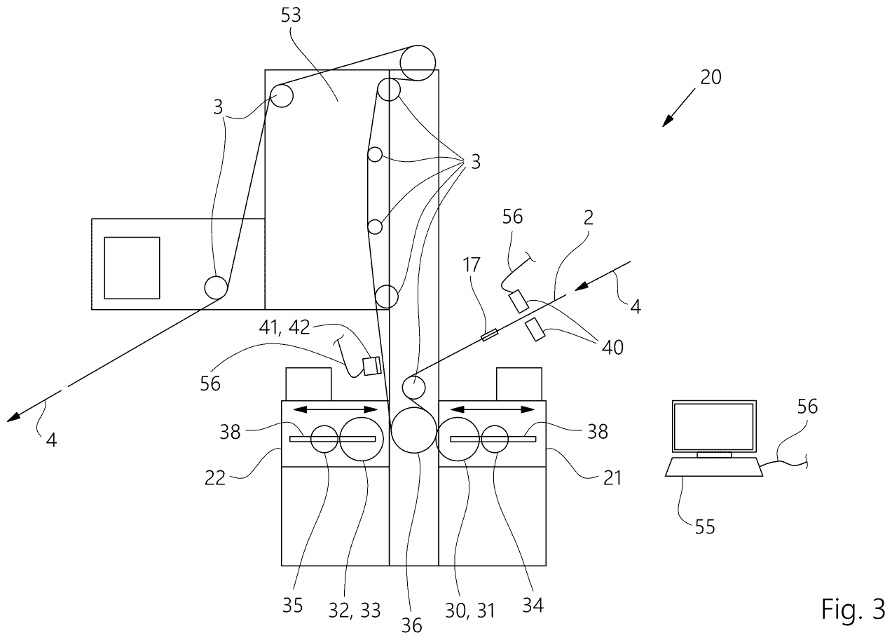

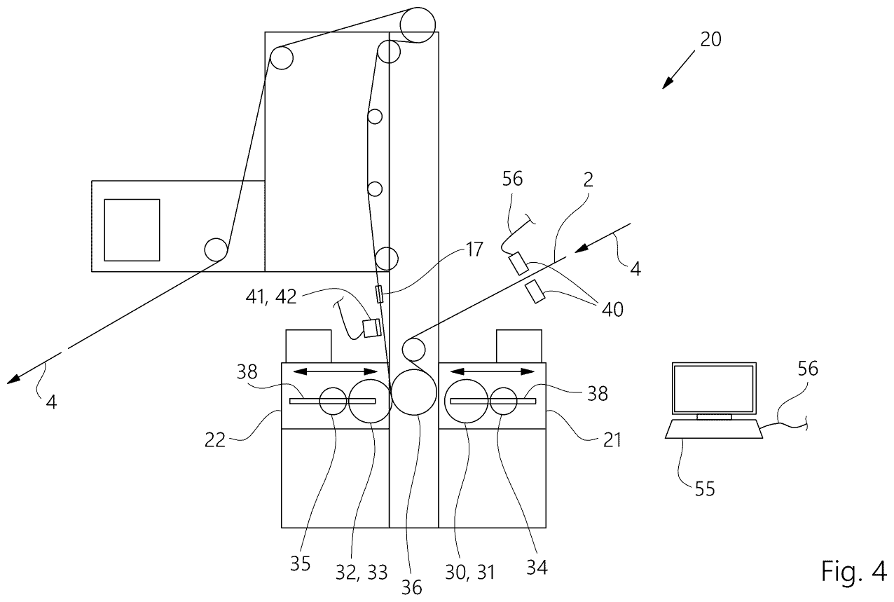

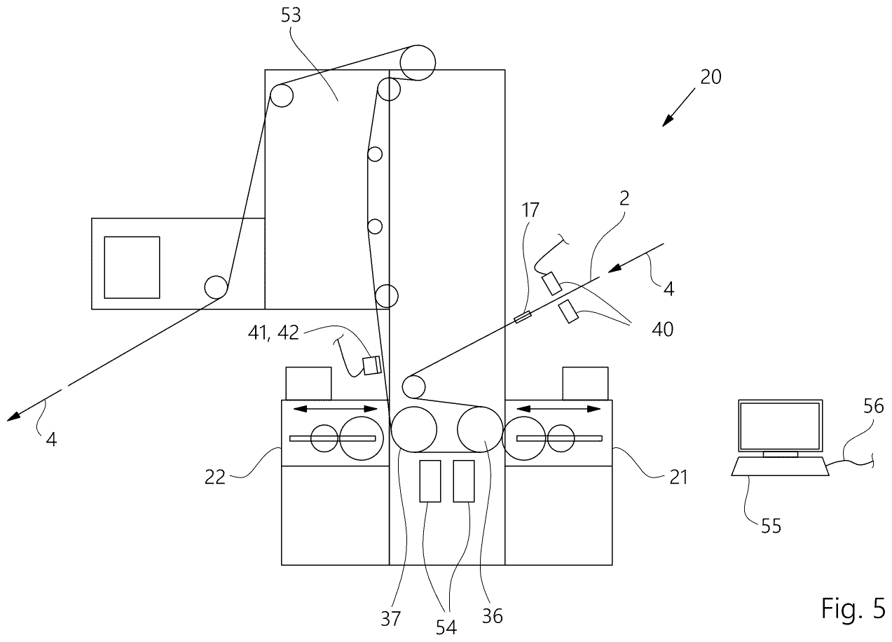

The web-fed printing press 1 includes at least one printing unit 20 (cf. FIGS. 3, 4 and 5), but preferably a plurality of printing units 20 for the production of multicolored prints. The printing unit 20 is configured as a double printing unit 20, i.e., it includes a first partial printing unit 21 and a second partial printing unit 22. The printing unit 20 is preferably configured for flexographic printing or gravure printing. The first partial printing unit 21 includes a first plate cylinder 30, in particular a flexographic or gravure plate cylinder, and preferably a first anilox cylinder 34 for printing a first print image 31 on the web 2; the second partial printing unit 22 includes a second plate cylinder 32, in particular a flexographic or gravure plate cylinder, and preferably a second anilox cylinder 35 for printing a second print image 33 on the web 2. The double printing unit 20 is configured for a flying job change, i.e., preferably either the first partial printing unit 21 prints the first print image 31 or the second partial printing unit 22 prints the second print image 33, wherein (cf. FIGS. 3 and 4) one of the two plate cylinders 30 or 32 is engaged with a central impression cylinder 36 and the other plate cylinder is disengaged therefrom. Alternatively (cf. FIG. 5), two impression cylinders 36 and 37 can be provided. In the case of a flying job change, a switchover is made between the two partial printing units 21 and 22, for which purpose each partial printing unit 21 and 22 is equipped with a disengagement device 38. The non-printing partial printing unit 21 or 22 can be set up for a new print job during production, i.e., provided with at least one new printing form.

FIGS. 3, 4 and 5 each show a double printing unit 20, to which a web 2 is fed in a transport direction 4 and from which the web 2 continues in a transport direction 4 to another unit. A superstructure with a number of guide rollers 3 for the web 2 and a dryer 53 for the printed web 2 is provided above the double printing unit 20. The double printing units 20 shown each include a first partial printing unit 21 and a second partial printing unit 22, as already described above.

A sensor 40 is disposed at least upstream of a first double printing unit 20 of the web-fed printing press 1 (or upstream of each double printing unit 20, cf. FIG. 1). The sensor 40 can be, for example, a web thickness sensor 40 for determining the thickness of the incoming web 2 and/or for detecting a splice 17; or, for example, a reflection sensor which detects an adhesive tape. The web-fed printing press 1 and/or the double printing unit 20 includes the computer 55, which is connected—preferably via a connection 56—to the sensor 40. The sensor 40 preferably continuously transmits its measured values to the computer 55, and the computer 55 then—after appropriate calculations—sends control signals 57 (cf. FIG. 1) to the double printing unit 20 or to the plurality of double printing units 20. In this respect, it can be seen in FIG. 1 that the control signals 57 preferably cause several double printing units 20 to switch over between the two partial printing units 21 and 22 in succession. In this way, it can be ensured that the switchover is coordinated with the passage of the splice 17 through the web-fed printing press 1 or its double printing units 20. When switching between the two partial printing units 21 and 22, the pressure/engagement of the plate cylinder 32 on its impression cylinder 36 or 37 and thus on the web can preferably be preset. This presetting can be selected depending on the web thickness of the web 15 following the splice 17; or vice versa. Similarly, the pressure/engagement of the anilox cylinder 34 on the plate cylinder 30 during the web change can be preset depending on the passage of the splice 17.

Furthermore, the double printing units 20 preferably each include a register sensor 41, which is disposed so that its measuring position 42 can be changed; preferably, the register sensor 41 can be moved transversely to the transport direction of the web 2. During a web change, the register sensor 41 can therefore be changed in its measuring position 42—preferably transversely to the web running direction, i.e., axially—as soon as the splice has passed the register sensor. The control signals 57 or corresponding control signals can also be used for this switchover process. A register can also be preset when the splice 17 passes through and during the synchronized switchover.

FIG. 5 also shows that intermediate dryers 54 can be disposed on the web path of the web 2 between the two impression cylinders 36 and 37. These intermediate dryers 54 and/or the dryers 53 of the web-fed printing press 1 can also be controlled by the computer 55 during a web change and the drying parameters can be changed from the first web 13 to the second web 15. This change also advantageously takes place at the time at which the splice 17 passes the respective dryer.

In addition to the double printing unit 20, the web-fed printing press 1 shown in FIG. 1 optionally also includes at least one single printing unit 50, in particular for flexographic printing or gravure printing. This single printing unit 50 can also be engaged and disengaged and can be controlled by the computer 55 in this respect.

Furthermore, the web-fed printing press 1 includes a further unit 51, which can preferably be formed as a rewinder 51 for the printed web 2. In addition to the unit 51 or alternatively thereto, the web-fed printing press 1 can include a further unit 52, which can preferably be formed as a further processing unit 52, for example a punching unit 52. The further processing unit 52 can also be controlled by the computer 55 during a web change with regard to a switchover process.

The figures show an example of switching from a first web 13 to a second web 15. It is clear that switching from the second web 15 to the first web 13 can also take place and that multiple switching to successive webs 13, 15 and others, which are to be processed, can take place.

The following is a summary list of reference numerals and the corresponding structure used in the above description of the invention:
1 web-fed printing press
2 web
3 guide rollers
4 transport direction
10 reel stand
11 unwinder
12 first reel
13 first web
14 second reel
15 second web
16 splice device
17 splice
18 feed unit
20 printing unit(s), in particular double printing unit(s) for flexographic printing
21 first partial printing unit, in particular flexographic printing unit
22 second partial printing unit, in particular flexographic printing unit
30 first plate cylinder, especially flexographic plate cylinder
31 first print image
32 second plate cylinder, in particular flexographic plate cylinder
33 second print image
34 first anilox cylinder
second anilox cylinder
36 (central) impression cylinder
37 further impression cylinder
38 disengagement device and/or engagement device
40 sensor, in particular web thickness sensor or reflection sensor
41 register sensor
42 measuring position
50 printing unit(s), in particular single printing unit(s) for flexographic printing
51 further unit, in particular rewinder
52 optional further processing units
53 dryer
54 intermediate dryer
55 computer
56 connection/s
57 control signals

1. A method for operating a web-fed printing press for producing printed products, the method comprising:
providing a web-fed printing press having a reel stand and a plurality of printing units;
carrying out a flying web change from a first web to a second web with a production of a splice;
making settings on the plurality of printing units in coordination with a passage of the splice through the web-fed printing press;
providing and configuring each of at least two of the plurality of printing units of the web-fed printing press as a respective double printing unit for flexographic printing and operating the double printing units for production of printed products, each double printing unit including a first partial printing unit and a second partial printing unit; and
activating or deactivating a respective first partial printing unit or second partial printing unit in coordination with the passage of the splice through the web-fed printing press, or
making a switchover from a first partial printing unit to a second partial printing unit of the respective double printing unit, or vice versa.

2. The method according to claim 1, which further comprises engaging:
the second partial printing units or respective flexographic plate cylinders of the second partial printing units, or
in a reverse case, the first partial printing units or respective flexographic plate cylinders the first partial printing units,
with the second web at a speed adapted to a speed of the second web at a time of switchover.

3. The method according to claim 1, which further comprises engaging:
the second partial printing units or respective flexographic plate cylinders of the second partial printing units, or
conversely, correspondingly the first partial printing units or respective flexographic plate cylinders of the first partial printing units,
with the second web with a pressure or advance adapted to the second web or web parameters of the second web at a time of switchover.

4. The method according to claim 1, which further comprises engaging:
anilox cylinders of the second partial printing units, or
in a reverse case correspondingly, anilox cylinders of the first partial printing units,
with the flexographic plate cylinders during switchover with a pressure or advance adapted to the second web or web parameters of the second web.

5. The method according to claim 1, which further comprises engaging:
the second partial printing units or respective flexographic plate cylinders of the second partial printing units, or
conversely, correspondingly the first partial printing units or respective flexographic plate cylinders of the first partial printing units,
with the second web with a pre-register adapted to the second web or web parameters of the second web at a time of switchover.

6. The method according to claim 1, which further comprises adapting a power of dryers to the second web or to web parameters of the second web at a time of switchover.

7. The method according to claim 1, which further comprises carrying out a print job change at a time of switchover.

8. The method according to claim 1, which further comprises successively disengaging or engaging:
flexographic plate cylinders of the first partial printing units, or
conversely, correspondingly flexographic plate cylinders of the second partial printing unit,
in coordination with the passage of the splice through the web-fed printing press.

9. The method according to claim 8, which further comprises disengaging:
the flexographic plate cylinders of the first partial printing units, or
in a reverse case correspondingly the flexographic plate cylinders of the second partial printing units,
directly before the splice or directly after the splice.

10. The method according to claim 1, which further comprises:
providing each of the double printing units with a respective register sensor, and
changing respective measuring positions of the register sensors in accordance with the passage of the splice through the web-fed printing press.

11. The method according to claim 1, which further comprises providing at least one substantially different parameter of the first web and the second web.

12. The method according to claim 11, which further comprises selecting the web parameter as one of web thickness, web width, web material, or web surface.

13. The method according to claim 11, which further comprises loading the web parameter from a database or from a memory on the web or on a web reel.

14. The method according to claim 12, which further comprises loading the web parameter from a database or from a memory on the web or on a web reel.

15. The method according to claim 1, which further comprises during the passage of the splice through the web-fed printing press:
setting at least one first partial printing unit for a first print job and using the at least one first partial printing unit to contribute to the first print job on the first web, and
setting at least one second partial printing unit for a second print job and using the at least one second partial printing unit to contribute to the second print job on the second web.

16. The method according to claim 1, which further comprises when a web width changes from a first width to a second larger or smaller width:
moving at least one sensor or another component disposed at a working distance from the first width to a safety distance from the second width and from the safety distance from the second width to a new working distance from the second width.

17. The method according to claim 1, which further comprises using printing units for gravure printing with gravure cylinders instead of the printing units for flexographic printing.

18. A method for operating a web-fed printing press, the method comprising:
carrying out a flying web change from a first web to a second web with a production of a splice; and
disengaging at least two plate cylinders of separate printing units from the first web or engaging each of the at least two plate cylinders of separate printing units with the second web in coordination with a passage of a splice through the web-fed printing press.

19. The method according to claim 18, which further comprises involving at least one double printing unit or at least one single printing unit in the disengagement or engagement.
